(19) United States
(12) Patent Application Publication
(10) Pub. No.: US 2026/0231934 A1
(43) Pub. Date: Aug. 13, 2026

(54) METHOD OF USE OF 1-OCTEN-3-OL IN PREVENTING AND CONTROLLING SOLENOPSIS INVICTA BURENS

(71) Applicant: Guizhou University, Guiyang (CN)

(72) Inventor: Wei ZHANG, Guiyang (CN)

(21) Appl. No.: 19/634,850

(22) Filed: Mar. 31, 2026

Related U.S. Application Data
(63) Continuation of application No. PCT/CN2026/084428, filed on Mar. 19, 2026.

(30) Foreign Application Priority Data
Mar. 21, 2025 (CN) 202510341423.8

(51) Int. Cl. A01N 31/02; A01P 7/04

(52) U.S. Cl. CPC A01N 31/02; A01P 7/04

(57) ABSTRACT

The present disclosure discloses a method of use of 1-Octen-3-ol in controlling S. invicta. 1-Octen-3-ol is toxic to S. invicta, and behavioral analysis shows that 1-Octen-3-ol also affects various social behaviors of S. invicta, including aggregation and nest cleaning (necrophoretic) behaviors, thereby achieving a control effect on S. invicta. 1-Octen-3-ol can also act as a repellent odor source to produce a repellent effect on S. invicta, thereby preventing them from spreading or invading specific areas. 1-Octen-3-ol has characteristics of being volatile, non-toxic, residue free, and insoluble in water, and does not cause residual pollution on land, is not affected by weather, and is safer and more effective compared to existing control means. It has broad application prospects in the control of S. invicta.

### TECHNICAL FIELD

The present disclosure relates to the technical field of pesticide, and specifically relates to a method of use of 1-Octen-3-ol in preventing and controlling Solenopsis invicta Burens (S. invicta).

### BACKGROUND

S. invicta is native to the Panama River basin in South America and is globally recognized as one of the 100 most dangerous invasive species. It has characteristics of fast reproduction, strong competitiveness, and great destructive power. After invasion, it can erupt into disasters in a short period of time, seriously affecting agricultural production, people's lives, and ecological environment in affected areas. At present, it has invaded 12 provinces in China, and invasion areas continue to expand northward and westward. It occurs more frequently in sunny areas such as embankments, riverbanks, wastelands, parks, highways, residential green belts, and adjacent forests. Occurrence of cases in farmland and forest areas is lighter than in green areas, with a highest altitude reaching 2800 meters, showing a natural diffusion trend from south to north, from low heat river valleys to cool areas, and from low altitude areas to high altitude areas. Every year, new districts and counties are invaded.

S. invicta pose significant threat to agricultural and forestry production, animal health, and biodiversity. They cause serious damage to the ecosystem of local ants by replacing them. For example, an invasion of S. invicta Buren has a negative impact on the population density and biodiversity of small arthropods (such as springtails and mites), thereby disrupting ecological functions of soil in agricultural systems. Similarly, the invasion of S. invicta damages seeds of dryland crops including wheat, sorghum, corn, soybeans, and cotton, leading to a decrease in agricultural yield. In addition, a presence of S. invicta has been proven to alter physical and chemical properties of agricultural soils, with significantly higher carbon to nitrogen ratios, organic matter content, and pH values in ant mounds compared to nearby soils. Being bitten by a S. invicta may cause allergic reactions (redness, itching, swelling), and in severe cases, can lead to acute chest tightness, difficulty breathing, and even shock, which can have a huge impact on agricultural production and tourism leisure.

The existing control methods for S. invicta include: (1) independent ant hill treatment method: in severely and moderately hazardous areas, visible ant hills can be directly treated with pesticides or powders or granules, which can effectively control more than 98% of ant hills. However, this method can only handle clearly visible ant hills and is prone to overlooking newly established ant nests that have not produced obvious ant hills; and most of the injection type products require 5-10 liters of pesticides to be added to each ant nest for effectiveness, with a large dosage, high cost, and easy to cause residual contamination of the land. (2) Bait method: the used S. invicta baits are mostly in granular or powdered form, such as ant killing baits, red ant net, etc. When using, about 10-30 grams of bait should be placed in ant nest or scattered in ant area. An effect time is slow, and having disadvantages of short service life and being greatly affected by weather factors (requiring no rain within 24 hours).

Existing independent ant hill treatment methods have problems such as omissions in control of new ant nests, high pesticides costs and susceptibility to residual soil pollution caused by irrigation methods, and high susceptibility of bait methods to weather conditions. Therefore, it is extremely necessary to develop new types of S. invicta control agents. 1-Octen-3-ol (CAS number: 3391-86-4, molecular formula C₈H₁₆O, structural formula CH₂═CHCH(OH)CH₂CH₂CH₂CH₂CH₃, English name 1-Octen-3-ol) is colorless to pale yellow oily liquid, and is an edible spice allowed to be used according to GB 2760-2014 and GB 29976-2013, and can be extracted from various spice crops or artificially synthesized. 1-Octen-3-ol has characteristics of being volatile, non-toxic, residue free, and insoluble in water. So far, there have been no reports on a control effect of 1-Octen-3-ol on S. invicta, especially through fumigation. Moreover, a dosage of 1-Octen-3-ol is minimal and the effect is significant, showing significant progress.

### SUMMARY

In view of this, one of the objectives of the present disclosure is to provide a method use of 1-Octen-3-ol in preventing and controlling of S. invicta Buren.

In some embodiments, preventing and controlling S. invicta includes killing S. invicta and/or reducing social behavioral abilities of S. invicta.

In some embodiments, the social behavioral abilities includes: aggregation ability and/or necrophoric behaviors.

In some embodiments, 1-Octen-3-ol is fumigated for preventing and controlling the S. invicta.

In some embodiments, a fumigation concentration of 1-Octen-3-ol is greater than or equal to 0.0702 μg/cm³.

In some embodiments, a fumigation concentration of 1-Octen-3-ol is 0.0702 μg/cm³.

The 1-Octen-3-ol of the present disclosure is toxic to S. invicta, and can kill and then control the S. invicta through fumigation, contact, or diet. 1-Octen-3-ol can also interfere chemical communication signal transmission between S. invicta colonies, making it difficult for them to accurately identify information about own species and nest environment. In terms of aggregation behavior, after treatment with 1-Octen-3-ol, mutual attraction and aggregation coordination between individuals of S. invicta are disrupted, and an originally tightly ordered group structure becomes loose, reducing efficiency in collective foraging, defending against external enemies, and building and maintaining nests. For the behavior of nest cleaning (necrophoretic), the 1-Octen-3-ol can cause abnormal perception and handling of dead species or nest debris by S. invicta, leading to deterioration of hygiene conditions inside a nest and easy spread of diseases, thereby weakening survival ability and reproductive success rate of an entire ant colony. This destructive effect on the social behavior of S. invicta disrupts survival system from within the ant colony. Compared with traditional control methods that only target individual killing, method provided by the present disclosure has a more comprehensive, in-depth, and long-term control effect, opening up new directions and strategies for comprehensive control of S. invicta. It has significant application value in the field of S. invicta management.

A second objective of the present disclosure is to provide a method of use of 1-Octen-3-ol in repelling S. invicta.

In some embodiments, a concentration of 1-Octen-3-ol as a repellent odor source is greater than or equal to 0.83 mg/mL.

In some embodiments, a concentration of 1-Octen-3-ol as a repellent odor source is 0.83 mg/mL.

A special odor of 1-Octen-3-ol can effectively interfere olfactory perception system of S. invicta, causing an actively avoidance of the corresponding area after sensing the special odor, thereby preventing the S. invicta from spreading or invading specific areas. The avoidance effect has high efficiency and persistence. Compared with traditional physical isolation or chemical repellents, 1-Octen-3-ol does not cause additional pollution and damage to environment, and a range of action is wider, can form an effective protective zone over a large area, effectively reducing the harm caused by S. invicta to crops, garden landscapes, and human living environments. It has shown unique advantages and great potential for application in the ecological control of S. invicta.

The third objective of the present disclosure is to provide the method of use of S. invicta killed by 1-Octen-3-ol in preventing and controlling normal S. invicta.

In some embodiments, normal S. invicta are prevented and controlled through letting the normal S. invicta abandon cleaning of corpses of S. invicta killed by 1-Octen-3-ol.

In some embodiments, a concentration of 1-Octen-3-ol used for killing the S. invicta is greater than or equal to 0.702 μg/cm³.

In some embodiments, a concentration of 1-Octen-3-ol used for killing the S. invicta is 0.702 μg/cm³.

Normal S. invicta are those that have not been treated with 1-Octen-3-ol. Normal S. invicta will give up cleaning corpses of S. invicta killed by 1-Octen-3-ol. The corpses of S. invicta killed by 1-Octen-3-ol will also have a series of negative effects on ant colonies, such as disease transmission, deterioration of nest environment, reducing ant work efficiency, survival ability, reproductive rate, and attraction of natural enemies and pests, ultimately leading to a decrease or even extinction of ant colonies and achieving control effects.

In summary, the present disclosure uses 1-Octen-3-ol to control S. invicta. 1-Octen-3-ol is toxic to S. invicta, and behavioral analysis shows that 1-Octen-3-ol also affects various social behaviors of S. invicta, including aggregation and nest cleaning (necrophoretic) behavior, thereby achieving a control effect on S. invicta. 1-Octen-3-ol can also act as a repellent odor source to produce a repellent effect on S. invicta, thereby preventing them from spreading or invading specific areas. 1-Octen-3-ol has characteristics of being volatile, non-toxic, residue free, and insoluble in water, which does not cause residual pollution on land and is safe and more effective. Therefore, 1-Octen-3-ol avoids problems of neglecting the control of new ant nests in existing independent ant hill treatment methods, high pesticides costs and susceptibility to soil residue pollution in irrigation methods, and high weather effects in bait methods. In particular, it can be used for fumigation to control S. invicta, and the amount of 1-Octen-3-ol used is minimal and an effect is significant, showing significant progress. It has broad application prospects in preventing and controlling S. invicta.

### BRIEF DESCRIPTION OF THE DRAWINGS

FIG. 1 shows survival curves of S. invicta exposed to different concentrations of 1-Octen-3-ol;

FIG. 2 shows half lethal time of fumigation with different concentrations of 1-Octen-3-ol;

FIG. 3 shows effect of different concentrations of 1-Octen-3-ol on avoidance behavior of S. invicta.

FIG. 4 shows differences in aggregation behavior of S. invicta exposed to 1-Octen-3-ol.

FIG. 5 shows differences in necrophoretic behavior of healthy S. invicta worker ants towards two types of S. invicta corpses that are killed by freezing and 1-Octen-3-ol.

FIG. 6 shows differences in necrophoretic behavior of frozen lethal corpses among surviving S. invicta exposed to 1-Octen-3-ol and methanol (control group).

### DETAILED DESCRIPTION OF THE EMBODIMENTS

The present disclosure will be described in detail below with reference to embodiments, which are only illustrative and not limited to a scope of application of the present disclosure. The present disclosure is not limited to the following embodiments or examples, and any modifications and variations that do not violate the spirit of the present disclosure should be included within a scope of the present disclosure. The experimental reagents used in the following examples can be purchased through commercial channels unless otherwise specified. 1-Octen-3-ol (abbreviated as octenol, purity ≥98.0%) used in the following examples is purchased from Shanghai Macklin Biochemical Co., Ltd; the S. invicta used are collected from Moon Lake Park in Xingyi City, Qiannan Autonomous Prefecture, Guizhou Province.

Embodiment 1: toxicity test of 1-Octen-3-ol on S. invicta (fumigation method)

Placing 15 S. invicta worker ants into a talc-coated 2 oz plastic cup. Placing two centrifuge tube covers in each plastic cup; a cover contains 50 μL of 10% sucrose solution which is a control group, while an other cover contains 0.5 μL of different concentrations of octenol methanol solution (octenol is diluted 1-1000 times in methanol) which is a experimental group. Final concentrations of octenol is 7.02 μg/cm³, 0.0702 μg/cm³, 0.0702 μg/cm³, and 0.00702 μg/cm³, (note: 7.02 μg/cm³ indicates using 7.02 μg octenol per cubic centimeter of spatial volume, and the rest is similar). Then tightly seal the plastic cup. Treating the control group cover with (0.5 μL) methanol. Evaluating fumigation activity by counting survival of S. invicta worker ants every 12 hours for 5 days. A cumulative survival rate is calculated according to the following formula: survival rate (%)=number of surviving test ants/total number of test ants×100. Each treatment involves three technical replicates, and the entire experiment is conducted using three independent batches of worker ants.

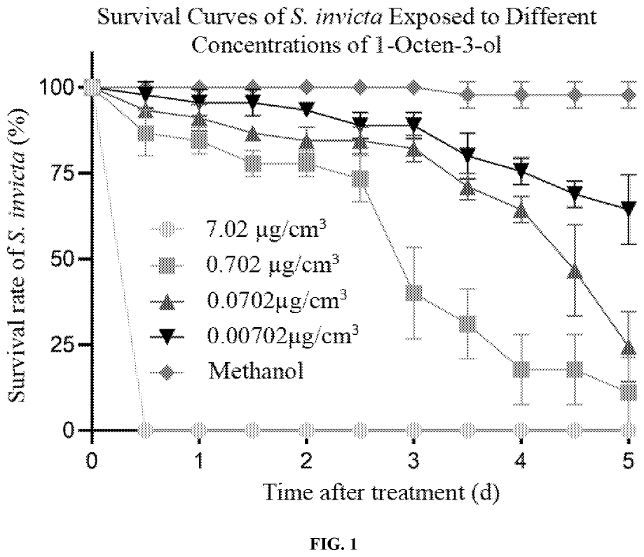

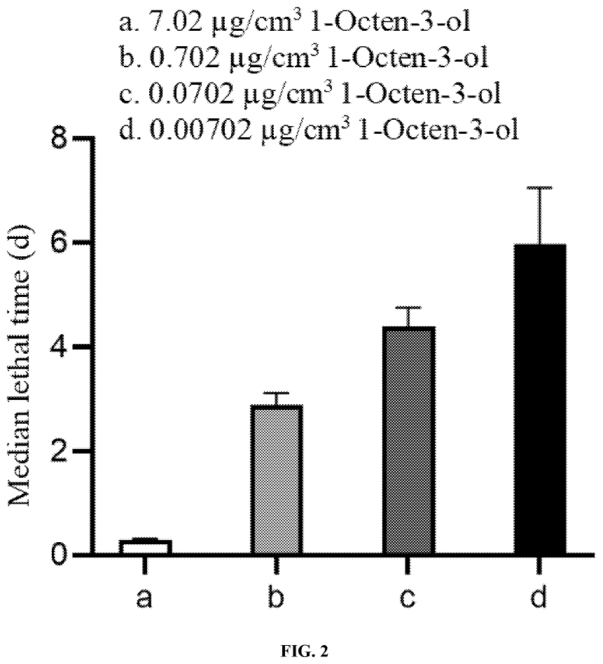

Fumigation toxicity effect: examining survival of S. invicta workers in a series of concentrations of sinenol fumigation experiments over a period of 5 days (FIG. 1). A calculation time (LT₅₀) for ants treated with a highest concentration of octenol (7.02 μg/cm³) to achieve a 50% mortality rate is 0.29 days (FIG. 2). When the concentration of octenol decreased by 10 times (0.702 μg/cm³), a LT₅₀ increases to 3 days, and a cumulative mortality rate after 5 days of treatment is 91%. When reducing a concentration of octenol (0.0702 μg/cm³ and 0.00702 μg/cm³), LT₅₀ increases to 4.4, a cumulative mortality rate after 5 days of treatment decreases to 87%; when LT₅₀ increases to 6.0 days, a cumulative mortality rate after 5 days of treatment decreases to 37%. Based on these data, a half lethal concentration (LC₅₀) of octenol is determined to be 0.0702 μg/cm³ using SPSS software probit.

Embodiment 2: avoidance behavior test of 1-Octen-3-ol on S. invicta

Conducting a behavioral selection experiment on octenol in S. invicta using a Y-shaped olfactometer, where the Y-shaped olfactometer contains a Y-shaped tube. Indoor lighting is provided by LED lights directly above the Y-shaped tube device. The experiment is conducted at a temperature of 25±2° C. and a relative humidity of 60±5%. Gas flow rate in the Y-shaped tube is 60 mL/s. Six concentrations of octenol methanol solutions are prepared by diluting a pure solution of 830 mg/mL octenol in methanol in a 10 fold gradient to 100000 fold. For each test condition, adding 10 μL of sample (octenol methanol solution or control methanol) onto a filter paper strip (3 cm×3 cm), and then inserting the filter paper strip into one arm of the Y-shaped tube as an odor source. Placing a same size filter paper strip containing (10 μL) methanol in the other arm of the Y-shaped tube as a control. Placing a test ant at a base of the Y-shaped olfactometer. If the ant passes through two-thirds of the length of the Y-shaped arm within 5 minutes, recording “selected”; otherwise, recording “no selection” not included in the data). To ensure no directional deviation, after testing 5 ants, switch the Y-shaped tube arm connected to the odor source to the other arm. A total of 15 ants are tested for each treatment. Each treatment consists three technical replicates (15 ants per replicate), and the entire experiment is conducted using three independent batches of worker ants.

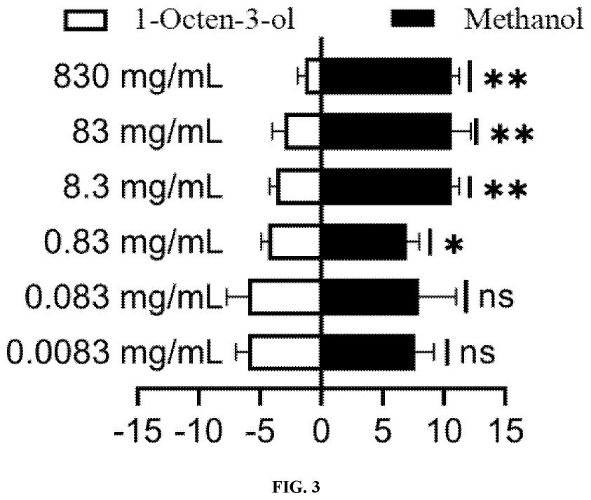

Avoidance behavior effect: conducting the behavioral selection experiment using a Y-shaped olfactometer to examine the response of S. invicta to octenol. S. invicta worker ants showed significant (P<0.01) avoidance behavior at octenol concentrations of 830 mg/mL with an avoidance level reaching 94.2%, 83 mg/mL with an avoidance level reaching 91.2%, 8.3 mg/mL with an avoidance level reaching 76.7%, and 0.83 mg/mL with an avoidance level reaching 72.2% (FIG. 3). No avoidance behavior is observed at lower test concentrations of 0.083 mg/mL and 0.0083 mg/mL.

Embodiment 3: aggregation behavior test of 1-Octen-3-ol on S. invicta

To measure a aggregation level, examining response quantity of S. invicta individuals to 0.0702 μg/cm3 octenol. When ants are placed at a base of a cup for an hour or longer, aggregation is considered positive. Gathering is defined as a formation of a group of three or more ants. The aggregation level is calculated using the following formula: aggregation level (%)=number of ants gathered/total number of ants multiplied by 100. Each treatment contains 20 ants and undergoes three technical repetitions. The entire experiment is repeated using three independent batches of worker ants.

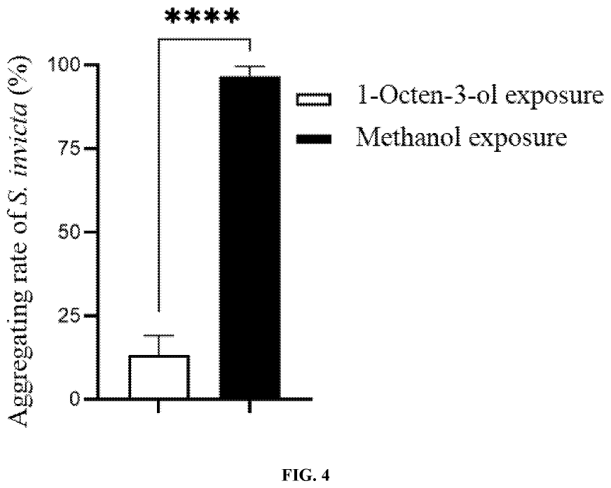

An impact of aggregation behavior: 97% of S. invicta worker ants showed aggregation behavior under methanol control exposure conditions, while under 0.0702 μg/cm³ octenol treatment, the aggregation behavior decreases to 13.3% (P<0.001, FIG. 4). Indicating that 1-Octen-3-ol reduces the aggregation behavior ability of S. invicta.

Embodiment 4: nest cleaning (necrophoretic) behavior test of 1-octen-3-ol on S. invicta

Conducting two types of experiments to investigate effects of exposure to octenol on a corpse removal behavior of S. invicta: (a) placing 15 untreated live worker ants in boxes containing five frozen ant corpses and five ant corpses killed by octenol (0.702 μg/cm³), arranging four corpses in a square and placing the remaining one in the center of the square. Three days later, recording a situation where live worker ants move any dead bodies to a “abandoned pile”. (b) Firstly, exposing 30 healthy worker ants to either octenol (0.0702 μg/cm³) or methanol. After 3 days of exposure, selecting 15 surviving worker ants and placing in boxes containing 5 frozen ant carcasses. Three days later, recording a situation where live worker ants move any dead bodies to the “abandoned pile”. Each experiment consists of three technical replicates (15 ants per replicate). The entire experiment is repeated using three independent batches of worker ants.

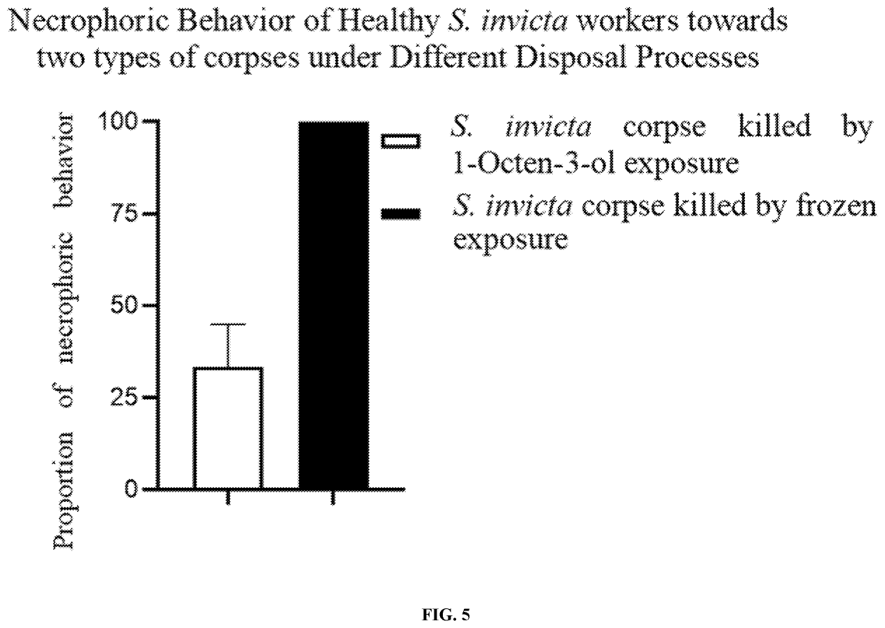

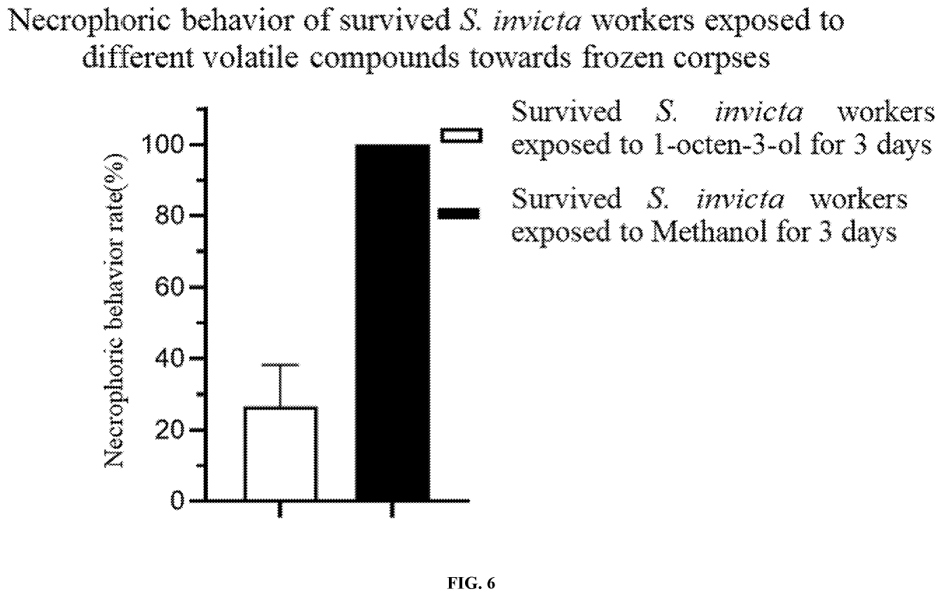

Necrophoretic behavior (corpses removal to the abandoned pile) impact: 100% of S. invicta killed by freezing are moved by healthy worker ants treated with methanol control, while only 33% of ants killed by octenol are moved (P<0.01, FIG. 5). When using octenol exposed surviving worker ants (survivors) for necrophoretic behavior analysis, the octenol exposed surviving worker ants shows a 27% reduction in corpse removal behavior of frozen killed ants, while the methanol exposed control worker ants maintained a 100% corpse disposal response to frozen killed ants (P<0.01, FIG. 6). The present embodiment indicates that octenol reduces the necrophoretic behavior of S. invicta, while healthy S. invicta reduce the cleaning of ants killed by octenol.

In summary, 1-Octen-3-ol is toxic to S. invicta and affects behavioral abilities, making it suitable for the control of S. invicta.

The conventional techniques and solutions not described in detail in the above embodiments are well-known in this field, so they will not be elaborated here. The above embodiments and/or experimental examples have described in detail the preferred embodiments of the present disclosure. However, the present disclosure is not limited to the specific details in the above embodiments. Within the scope of the technical concept of the present disclosure, various simple modifications can be made to the technical solution of the present disclosure, all of which are within the scope of protection of the present disclosure.

What is claimed is:

1. A method of use of 1-Octen-3-ol in preventing and controlling S. invicta, comprising: 1-Octen-3-ol is fumigated for preventing and controlling the S. invicta, wherein a fumigation concentration of 1-Octen-3-ol is greater than or equal to 0.0702 μg/cm³.

2. The method of use of 1-Octen-3-ol in preventing and controlling S. invicta according to claim 1, wherein preventing and controlling S. invicta comprise killing S. invicta and/or reducing social behavioral abilities of S. invicta.

3. The method of use of 1-Octen-3-ol in preventing and controlling S. invicta according to claim 2, wherein the social behavioral abilities comprise: aggregation ability and/or corpse disposal ability.

4. A method of use of S. invicta killed by 1-Octen-3-ol in preventing and controlling S. invicta, wherein a concentration of 1-Octen-3-ol in S. invicta killed by 1-Octen-3-ol is greater than or equal to 0.702 μg/cm³.

5. The method of use of S. invicta killed by 1-Octen-3-ol in preventing and controlling S. invicta according to claim 4, wherein S. invicta are prevented and controlled through causing the S. invicta to abandon cleaning of corpses of S. invicta killed by 1-Octen-3-ol.
